(19) United States
(12) Patent Application Publication
(10) Pub. No.: US 2008/0270194 A1
(43) Pub. Date: Oct. 30, 2008

(54) SYSTEMS AND METHODS FOR GUARANTEEING INCOME BASED IN PART ON AN INVESTMENT ACCOUNT

(75) Inventors: RENEE COCHINGYAN WEST, NORTH OAKS, MN (US); ADAM MICHAEL BROWN, MAPLE GROVE, MN (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: ALLIANZ LIFE INSURANCE COMPANY OF NORTH AMERICA, MINNEAPOLIS, MN (US)

(21) Appl. No.: 12/109,916

(22) Filed: Apr. 25, 2008

Related U.S. Application Data
(60) Provisional application No. 60/926,148, filed on Apr. 25, 2007.

(51) Int. Cl. G06Q 40/00

(52) U.S. Cl. 705/4

(57) ABSTRACT

Systems and methods for correlating guaranteeing income payments based in part on the cash value of a third-party investment asset, for a specified term or for life are disclosed. A preferred embodiment allows the covered person to realize guaranteed income regardless of any decrease in the cash value of the investment asset. Some embodiments of the systems and methods disclosed herein also increase the income payments when correlated against the appreciated cash value of the investment asset.

### CROSS REFERENCE TO RELATED APPLICATIONS

This application claims priority to Provisional U.S. Patent Application Ser. No. 60/926,148, filed Apr. 25, 2007 which is hereby incorporated by reference in its entirety.

### FIELD OF THE INVENTION

The invention disclosed herein relates generally to the field of annuity contracts, and more particularly to systems and methods for managing an investment product that correlates guaranteed income payments for a specified term to the value of a third-party investment asset in order to guarantee income to an individual.

### BACKGROUND OF THE INVENTION

An annuity is a close financial cousin to a life insurance contract and pays periodic income benefits for a specific period of time or over the course of a lifetime. Life insurance companies offer annuities. There are two basic types of annuities: deferred and immediate. Deferred annuities allow assets to grow over time before being converted to income payments. Immediate annuities begin payments immediately, or within a year of purchase.

The act of converting a deferred annuity to income is known as annuitization. The value of funds being converted to income is known as the annuitization value. In sum, a deferred annuity allows the covered person to accumulate funds for retirement and then receive a guaranteed income payable for a specified period or for life.

An annuity may be fixed or variable. The U.S. Securities and Exchange Commission typically does not regulate fixed annuities, but it does regulate variable annuities. In a fixed annuity, all assets underlying the annuity are held in the insurer's general account, with the insurer bearing the investment risk. In a variable annuity, the insurer will hold all the assets underlying the annuity in a separate account and the annuity owner bears the investment risk, directly participating in the gains and losses of those assets, net of any fees. These separate account assets are composed of assets in specified variable annuities which are invested in specified investment subaccounts provided within the annuities. These investment subaccounts are not publicly traded.

In both type of annuities (fixed and variable), the insurer owns the assets underlying the contracts (subject to 817(h) and investor control rules under the Internal Revenue Code of 1986 (IRC) for variable annuities).

In entering an annuity contract, the annuity owner pays a premium in return for guaranteed income payments. Many deferred annuities allow annuity owners to deposit additional money, possibly restricted to periods of time or to maximums or minimums. In return, the annuity owner is entitled to receive an income stream in the form of periodic payments after a certain holding period, which is known in the art as the accumulation phase or period. Typically the annuity owner can choose when to annuitize and begin receiving income payments from the insurer. The period over which income is received is known as the payout or income phase or period.

Outside of an annuity, an individual can attempt to self-fund their retirement income by making regular withdrawals from their asset portfolio. Self-funding allows the individual to retain control and ownership over their assets, instead of exchanging them for an annuity contract which could guarantee income payments for life. With self-funding, however, there is no guarantee that those withdrawals can continue for their lifetime without depleting the asset portfolio. Investment return performance shortfall and/or volatility as well as longevity are two risks which could significantly impact the ability of the asset portfolio to support these withdrawals for the individual's entire lifetime.

### SUMMARY OF THE INVENTION

There is a need for systems and methods that ameliorate the risks to the individual or annuity owner associated with self-funding of retirement income, using an investment account the investor owns and controls, that is maintained by a financial institution. The risks associated with retirement self-funding may be reduced by attaching to the investment account a guarantee to provide income, in case the individual outlives their assets. A financial institution, as used herein and understood in the art, includes banks, brokerage firms, wirehouses, managed fund companies, life insurance companies or other investment or financial services companies. The present invention is a system and method configured to reduce the risks to the owner associated with the self-funding of a retirement plan by guaranteeing lifetime income as a percentage or factor of a Benefit Base. The lifetime is that of the covered person. The system could also be used to guarantee deferred annuity payments for a fixed period of time. The nominal Benefit Base may comprise part or all of the value of the investment contract with a financial institution, called the covered account. Typically the financial institution will be a third party. The Benefit Base constitutes the basis upon which an income payment guarantee may be computed. The systems and methods disclosed herein may include determining the nominal value of the Benefit Base by considering the accumulated value of the covered account and any additions made to or withdrawals taken from that account. In the systems and methods disclosed herein, the guarantee is anticipated for an account owner's coverage of his or her own assets and lifetime, or two covered persons' assets and lifetimes; but nothing herein should be construed to limit the systems and methods disclosed herein to this combination; the covered person may comprise any legal person, who may or may not own the underlying assets or receive income therefrom.

The systems and methods further disclose guaranteed variable or fixed payment amounts to the covered person. To guarantee the lifetime income payments, the insurer may charge a fee against either the value of the Benefit Base or against the value of the covered account. The payment percentage can be fixed for life or be tied to the current age of the covered person. Payments may periodically increase by a certain amount or by an amount tied to an increase, if any, in the value of the covered account or an external index.

As long as the value of the covered account exceeds a specified minimum, the method evaluates the Benefit Base to determine how much the covered person can withdraw as income without affecting the income guarantee. The amount the covered person can withdraw over a specified period is the Modal Withdrawal Limit (“MWL”). An embodiment of the method permits a guaranteed amount of income that insulates the covered person from any loss occasioned by a decrease in the value of the covered account. An embodiment of the method also provides the covered person with higher guaranteed income as the value of the covered account appreciates and the guaranteed income may increase even if the covered account is still below the original Benefit Base level. In another embodiment, if the covered person withdraws amounts in excess of the MWL, the value of the Benefit Base may decrease and therefore the MWL may decrease.

Under an embodiment comprising a variable MWL factor, the factor may include an age step-up feature. For purposes of non-limiting example only, if the covered person is between 50 and 59 years old at the time of the initial distribution or withdrawal, the MWL can be 4% of the Benefit Base. When the covered person reaches age 60, the MWL factor could increase, for example, to 5%. Further increases could occur, for example, at age 70, 80, etc. Such increases may depend on whether the increased MWL factor, as applied to the value of the covered account, exceeds the current MWL. If so, the method and system disclosed herein provides for paying the covered person the higher amount.

As long as the value of the covered account is above a specified minimum, the covered person receives income in the form of withdrawals from the covered account. Once the value of the covered account falls to or below the minimum, the covered person receives income in the form of payments from the insurer. Under one embodiment, the specified minimum is zero, and the covered account is exhausted before the insurer makes income benefit payments for the life of the covered person based on the then current MWL. Under another embodiment, the specified minimum may be one year's MWL, and similarly once the covered account can no longer support one year's income withdrawals, the insurer may receive the remaining assets as a final premium and may make income benefit payments for the life of the covered person based on the then current MWL.

### DESCRIPTION OF THE DRAWINGS

FIG. 1 shows, in flowchart form, one embodiment of the invention.

### DETAILED DESCRIPTION

Aspects of the invention are described as a method of control or manipulation of data, and may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disc storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the following detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

In this disclosure there are at least two distinct time periods discussed. The “term of the annuity,” typically beginning at the end of the accumulation period, represents the time duration for which payments are guaranteed and can be for a specified amount of time or measured based on the life of a person. The “modal period” represents the frequency at which the calculations pertaining to Benefit Base and modal withdrawal limits are calculated and can by weekly, monthly, yearly, etc. The periodic payments are made at the same or greater frequency than the modal period. Both the modal period and the periodic payments begin when the term of the annuity begins. The periodic payments end when the term of the annuity is over.

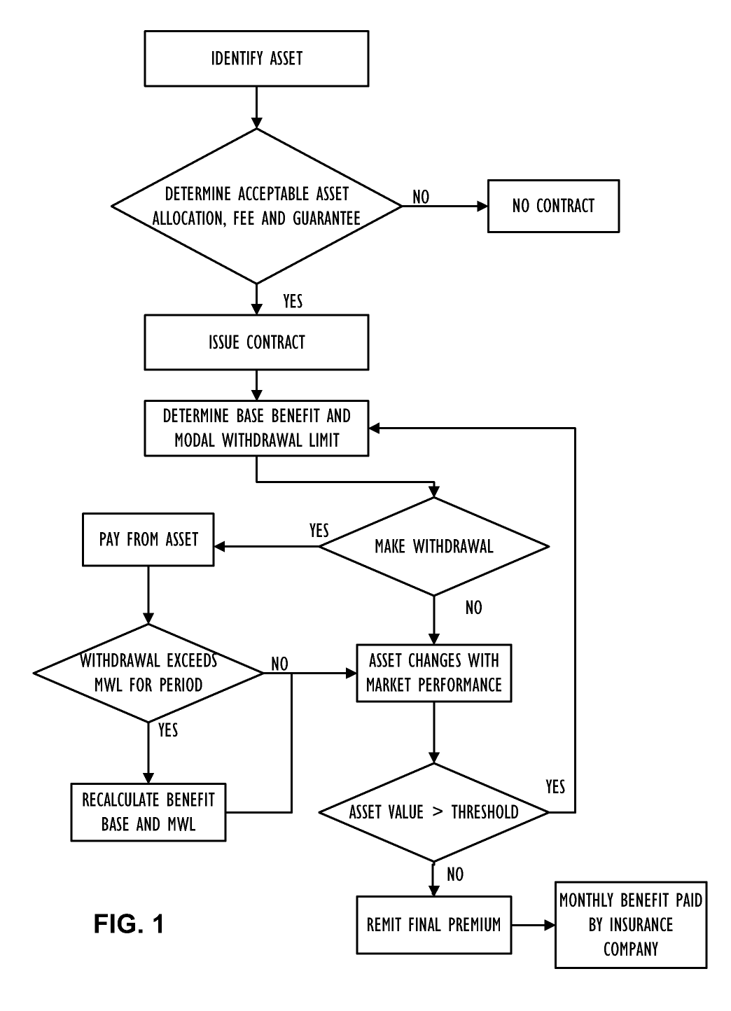

In the systems and methods disclosed herein, one embodiment is illustrated in FIG. 1 and includes an investment account that the prospective covered person has already established with a financial institution. The prospective covered person can designate that account as the covered account. To guarantee the lifetime income payments, the insurer may require the covered account to satisfy an acceptable asset allocation profile that will be defined in the contract between the insurer and the prospective covered person.

If a given investment asset qualifies as an acceptable asset to which the guarantee of lifetime income payments supplemental contract can be attached, an embodiment requires the insurer to issue the guarantee of lifetime income as a supplemental contract together with any associated certificates. In one embodiment, the guarantee contract is a group fixed deferred annuity contract issued to a financial institution with individual certificates issued to the covered persons. In another embodiment, an individual annuity contract may be issued directly to the covered person. The covered person's contract or certificate may be written against the covered account. The amount of principal invested in the account may vary. For example, the guarantee may require that upon issue the covered account value be between $50,000 and $5 million.

The covered person may also utilize an optimizer to determine which assets to protect and the optimal amount of those assets to protect. The inputs to the optimizer may include the covered person's current asset types, the amounts of these assets, standard actuarial measures (e.g. the covered person's current age, gender, life expectancy), the covered person's desired retirement age, and the covered person's desired amount of retirement income. The outputs of the algorithm may include the optimal amount of assets to insure, investment strategies to meet income goals, and the likelihood of meeting these financial goals. For example, the covered person may elect to segregate 70% of their investment account balance as the covered account. They would take withdrawals from the unprotected 30% of assets for an estimated period of time, after which withdrawals may begin coming out of the covered account. At that point, the Benefit Base and MWL are calculated, based on the value of the covered account.

In one embodiment, the accumulation phase begins at the effective date of the contract with the nominal Benefit Base equal to the value of the covered account. The Benefit Base may comprise the greater of the maximum anniversary value, or a 5% rollup on the initial value of the covered account as illustrated in the table 1. In another embodiment, the Benefit Base may be based in part on the maximum quarterly anniversary value, or other maximum modal anniversary value, a rollup other than 5%, or a rollup based on the changes of an external index.

TABLE 1

| Initial | | Net | Covered | Maximum | | Benefit Base |
|---|---|---|---|---|---|---|
| Investment | Contract | Investment | Account | Anniversary | | greatest of (d), |
| Amount | Year | Yield | Balance | Value | 5% Rollup | (e), and (f) |
| (a) | (b) | (c) | (d) | (e) | (f) | (g) |
| $100,000 | 1 | +10% | $110,000 | $110,000 | $105,000 | $110,000 |
| | 2 | −2% | $107,800 | $110,000 | $110,250 | $110,250 |
| | 3 | +4% | $112,112 | $112,112 | $115,763 | $115,763 |
| | 4 | +15% | $128,929 | $128,929 | $121,551 | $128,929 |

The rollup may be capped at a certain percentage of the initial investment amount. For example, the rollup may be capped at 200% of its initial value. In various embodiments the accumulation phase may end with the initial withdrawal, or as declared by the covered person. In the latter case, a withdrawal taken during the accumulation phase may reduce the Benefit Base, and its associated maximum anniversary value and 5% rollup, as described in more detail below.

The decumulation phase or term of the annuity begins when the accumulation phase ends. During the decumulation phase the covered person takes income in the form of withdrawals from the covered account.

The Benefit Base may change when money is added to or withdrawn from the covered account, or when a reset occurs. The Benefit Base may be increased by the same amount as money added to the covered account. The Benefit Base may be unchanged for withdrawals which do not exceed the Modal Withdrawal Limit, and may be reduced for withdrawals in excess of this amount, as described in more detail below. Upon a reset of the Benefit Base, the Benefit Base can equal the current value of the covered account.

As an illustrative and non-limiting example consider the following scenarios for determining the Benefit Base and modal withdrawal limit. At the time a contract is issued, the Benefit Base is equal to the value of the investment account. After this time there are several circumstances which can cause the Benefit Base to change. In a first scenario any additional amounts deposited into the investment account will increase the Benefit Base by the amount of the deposit. In a second scenario any withdrawal amounts from the investment account which exceed the modal withdrawal limit for the period will decrease the Benefit Base in the same proportion as this withdrawal amount reduced the investment account. In a third scenario if the value of the investment account multiplied by the modal withdrawal limit factor is greater than the current modal withdrawal limit, the Benefit Base will be changed (either increased or decreased) to equal the current value of the investment account.

In one embodiment, the MWL equals the payment percentage or MWL factor multiplied by the Benefit Base. If the owner withdraws no more than the MWL each period, payments are guaranteed for the term of the annuity regardless of the investment performance of the account. Any cumulative withdrawals for a modal period exceeding the MWL will trigger a recalculation (reduction) of the Benefit Base and hence, the MWL. If the owner withdraws less than the MWL in a given year, one embodiment provides for the unused withdrawal amount to be guaranteed as income in a future year, or years.

The MWL may be recalculated periodically. If the recalculated MWL exceeds the current MWL, the method provides that the MWL going forward can be the recalculated value. In various embodiments such a recalculation may apply the MWL factor to the value of the covered account, or may increase the MWL directly by an amount determined by an external market or inflation index, or by the performance of the covered account. The modal withdrawal limit may technically not be calculated until the time of the initial withdrawal from the investment account (prior to this it is not necessary). At the time of the initial withdrawal, the modal withdrawal limit equals the MWL factor multiplied by the Benefit Base. The modal withdrawal limit will then be recomputed only when the Benefit Base changes.

In one embodiment of the systems and methods disclosed and described herein, the decumulation phase must begin between the ages of 50 and 90. If joint owners hold the account, the owner with the greater life expectancy based on actuarial calculations can be used to determine the MWL. In an embodiment of joint covered persons, income benefits are not reduced upon the first death. In a refinement of this or another embodiment, joint income payouts are available only to spouses. In an embodiment of joint covered persons, a death benefit may be made available to the surviving joint covered person or persons upon the death of a covered person.

To minimize the effects of inflation, the systems and methods herein provide for a cost of living adjustment (COLA). In an embodiment shown in Table 2, the systems and methods provide, as an example, a 3% annual COLA. This table reflects the lock in value of the MWL factor based on the option selected. As will be apparent to one skilled in the art if the COLA option is selected the lock in value of the account will be lower (as a starting percentage) when a COLA adjustment is selected. In this embodiment, the Benefit Base, and hence, the MWL may increase each year by a compounded rate of COLA. In another embodiment, the effects of inflation can be minimized by annually increasing the Benefit Base relative to the change in a consumer price index. If the covered person elects a COLA option, the MWL factor can be reduced, for example, by 1%.

TABLE 2

| Age at MWL | | |
|---|---|---|
| Calculation | MWL factor | COLA MWL factor |
| 50-59 | 4% | 3% |
| 60-69 | 5% | 4% |
| 70-79 | 6% | 5% |
| 80+ | 7% | 6% |

The systems and methods provide for a reduction to the Benefit Base if the covered person withdraws more than the MWL in a given year. In one embodiment the Benefit Base is reduced by an equal dollar amount as the account value is reduced by the withdrawal. In another the Benefit Base is reduced by an equal percentage as the account value is reduced by the withdrawal. In another embodiment the Benefit Base reduction is computed in actuarial future benefits equivalent to the reduction in covered account value, and reduces the Benefit Base accordingly. Other methods are known in the art.

If the covered account is tax qualified (i.e. funded with pre-tax dollars), any required minimum distribution from that account may not be treated as an excess withdrawal if taking the required minimum distribution results in a total withdrawal in excess of the MWL.

The systems and methods herein may provide for a benefit payable upon the death of the covered person or one of the covered persons if the account is a joint guarantee account. There are several embodiments of this option, all of which pay whatever shortfall there may be between the value of the covered account and the death benefit. In one embodiment, the benefit would be based on the maximum covered account anniversary value, adjusted for any withdrawals. In a second embodiment, the benefit would be based on the greater of the maximum anniversary value or the 5% rollup value, capped at twice the initial Benefit Base, adjusted for any additions made or withdrawals taken. In a third embodiment, the amount payable would be the initial Benefit Base, plus additions contributed to the covered account and adjusted for any withdrawals.

To receive the lifetime payment guarantee, the method and system provide for a charge to the covered person as long as the covered account has value greater than zero. The charge can be assessed at various frequencies as a percent of the account balance or of the Benefit Base. For example, the covered person may be charged a daily amount in a manner similar to a mortality and expense (M&E) charge on a variable annuity, which is well known in the art. In one embodiment the charge is deducted on calendar quarters to accommodate the transactional schedule of the financial institution managing the covered account. In another embodiment an estimated charge is deducted at the start of each period and refunded or augmented at the end of each period to reflect actual experience. In an additional embodiment the charge is not deducted from the covered account at all but from an separate, unprotected investment account. If the covered person utilized an optimizer, the charge will be assessed only on the protected portion of the assets. The methods and systems disclosed herein provide for a fixed charge or a charge adjusted in accordance with changing conditions in the competitive landscape and in financial markets. For purposes of non-limiting example only, the charge may be fixed for two years from the date of issuing the contract. A charge for a death benefit could be assessed in a similar manner to the charge for a lifetime payment guarantee.

If the covered person cancels the contract, the method and system described herein may prevent the owner from reapplying for new coverage for a period of time after cancellation.

The methods and systems described herein provide that if the third party financial institution cancels the contract, or otherwise terminates its agreement with the insurer to maintain its covered accounts, the insurer provides to each covered person a level of portability for the guarantee. In one embodiment the covered accounts may be transferred to the insurer with no change in guarantee. In another embodiment, the covered accounts may be transferred to a fourth party and the guarantee assumed under the terms of the insurer's contract with the fourth party.

In one embodiment of the methods and systems described herein, the financial institution sends withdrawals from the covered account directly to the account owner(s). Thus, over time, the covered account is drawn down. The decumulation phase ends when the value of the covered account falls to or below a specified minimum. In this event the covered person will remit to the insurer the entire remaining value of the covered account as a final premium and the decumulation phase ends. The guarantee of lifetime income payments from the insurer follows the decumulation phase and is called the benefit phase. The amount of the lifetime income payments may be based on the current MWL. The frequency of lifetime payments may be different than the modal period. In one embodiment, the start date for lifetime income payments may be the start of the next modal period. In another embodiment, the start date for lifetime income payments may be determined based on total withdrawals for the modal period as a portion of the MWL. For example, if the MWL is $6,000 per year and the covered person withdrew $1,500 at the beginning of the year, which caused the account value to fall below the specified minimum, the insurer may pay $500 per month beginning in three months. Such guarantee of lifetime income payments may be paid from the insurer either into the covered account, to the covered person through the financial institution, or directly to the covered person. In this or another embodiment, the financial institution sends statements and confirmations to the covered account owner. In addition, the financial institution will perform any tax reporting to the covered account owner(s) on payments from the account. The insurer may send any required regulatory certificate statements directly to the certificate owner(s) and will send any required tax reporting when payments are from the guaranteed certificate.

In one embodiment of the methods and systems described herein, the financial institution and insurer regularly exchange information via electronic data feeds. The data feeds from the financial institution to the insurer communicate information about the covered person and their account, including but not limited to: account balances, premium payments, withdrawals, and asset allocations. The insurer may use this information to calculate certain values to send back to the financial institution information including but not limited to: Benefit Base, insurance and administrative charges, and Modal Withdrawal Limits.

Various changes in the details of the illustrated operational methods are possible without departing from the scope of the following claims. For instance, illustrative flow chart steps of FIG. 1 may perform the identified steps in an order different form that disclosed here. Alternatively, some embodiments may combine the activities described herein as being separate steps. Similarly, one or more of the described steps may be omitted, depending upon the specific operational environment the method is being implemented in. In addition, acts in accordance with FIG. 1 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. An annuity product comprising a guarantee of periodic payments for a term wherein guarantee is based at least in part on a value of an external asset account.

2. The annuity product of claim 1 wherein the external asset account is under the control of the entity receiving the guarantee.

3. The annuity product of claim 1 wherein the external asset account does not contain annuities.

4. The annuity product of claim 1 wherein the external asset account is maintained by a financial institution.

5. The annuity product of claim 1 wherein the term is for a set period of years.

6. The annuity product of claim 1 wherein the term is for a covered person's lifetime.

7. The annuity product of claim 1 wherein the guarantee is provided for one or more account owners.

8. The annuity product of claim 7 wherein the term is for lifetime of longest surviving covered person.

9. The annuity product of claim 1 wherein the term does not start until some defined point in the future.

10. The annuity product of claim 1 wherein the guarantee of periodic income is based on a rollup value of the external asset account.

11. The annuity product of claim 1 wherein the periodic payments may increase by an amount tied to an increase, if any, in the value of an external index.

12. The annuity product of claim 1 wherein the periodic payments may increase by an amount tied to an increase, if any, in the value of the external asset account.

13. The annuity product of claim 1 wherein the guarantee of periodic income is based on actuarial factors pertaining to a covered person.

14. The annuity product of claim 1 wherein the guarantee of periodic income is recalculated if the external asset account is withdrawn in excess of a modal withdrawal limit.

15. The annuity product of claim 1 wherein if the external asset account is withdrawn by an amount less than a modal withdrawal limit for a modal period, difference will be added to the modal withdrawal limit for a subsequent modal period.

16. The annuity product of claim 1 wherein a lump sum payment is paid based upon death of one or more covered persons.

17. The annuity product of claim 1 wherein charges are assessed based on the value of the external asset account.

18. The annuity product of claim 1 wherein charges are assessed based on the value of a benefit base.

19. The annuity product of claim 1 wherein if the value of the external asset account multiplied by the modal withdrawal limit factor is greater than the current modal withdrawal limit, benefit base will be changed to equal current value of the external asset account.

20. The annuity product of claim 4 wherein daily data feeds from the financial institution to insurance company and vice versa are required to administer the annuity product.

21. The annuity product of claim 1 wherein an optimizer is utilized to determine an optimal portion of assets in the external asset account to be incorporated into the annuity product.

22. The annuity product of claim 1 wherein the guarantee of periodic income is paid from the external asset account until value of the external asset account reaches a threshold value.

23. The annuity product of claim 22 wherein the guarantee of periodic income is paid by the entity issuing the guarantee after the value of the external asset account reaches the threshold value.

24. An annuity product comprising:
an external asset account;
a guarantee of periodic income for a specified term determined by a value of the external account;
wherein the external asset account is maintained by a third party that is not providing the guarantee.

25. The annuity product of claim 24 wherein the external account is under the control of entity receiving the guarantee.

26. The annuity product of claim 24 wherein the external asset account does not contain annuities.

27. The annuity product of claim 24 wherein the external asset account is maintained by a financial institution.

28. The annuity product of claim 24 wherein the term is for a set period of years.

29. The annuity product of claim 24 wherein the term is for a covered person's lifetime.

30. The annuity product of claim 24 wherein the guarantee is provided for one or more account owners.

31. The annuity product of claim 30 wherein the term is for lifetime of longest surviving covered person.

32. The annuity product of claim 24 wherein the term does not start until some defined point in the future.

33. The annuity product of claim 24 wherein the guarantee of periodic income is based on a rollup value of the external asset account.

34. The annuity product of claim 24 wherein the periodic payments may increase by an amount tied to an increase, if any, in the value of an external index.

35. The annuity product of claim 24 wherein the periodic payments may increase by an amount tied to an increase, if any, in the value of the external asset account.

36. The annuity product of claim 24 wherein the guarantee of periodic income is based on actuarial factors pertaining to a covered person.

37. The annuity product of claim 24 wherein the guarantee of periodic income is recalculated if the external asset account is withdrawn in excess of the modal withdrawal limit.

38. The annuity product of claim 24 wherein if the external asset account is withdrawn by an amount less than a modal withdrawal limit for a modal period, difference will be added to the modal withdrawal limit for a subsequent modal period.

39. The annuity product of claim 24 wherein a lump sum payment is paid based on death of one or more covered persons.

40. The annuity product of claim 24 wherein charges are assessed based on the value of the external asset account.

41. The annuity product of claim 24 wherein charges are assessed based on the value of a benefit base.

42. The annuity product of claim 24 wherein if the value of the external asset account multiplied by the modal withdrawal limit factor is greater than the current modal withdrawal limit, benefit base will be changed to equal current value of the external asset account.

43. The annuity product of claim 27 wherein daily data feeds from the financial institution to insurance company and vice versa are required to administer the annuity product.

44. The annuity product of claim 24 wherein an optimizer is utilized to determine an optimal portion of assets in the external asset account to be incorporated into the annuity product.

45. The annuity product of claim 24 wherein the guarantee of periodic income is paid from the external asset account until value of the external asset account reaches a threshold value.

46. The annuity product of claim 45 wherein the guarantee of periodic income is paid by the entity issuing the guarantee after the value of the external asset account reaches the threshold value.

47. A method of guaranteeing income payments comprising:
determining a value of an external asset account;
calculating a periodic payment for a term;
calculating a value of a guarantee to ensure periodic payment will be paid by guarantor even if the value of the external asset account falls below a set amount; and
setting parameters for the entity receiving the guarantee to maintain control of the external asset account.

48. The method of claim 47 wherein the external account is under the control of entity receiving the guarantee.

49. The method of claim 47 wherein the external asset account does not contain annuities.

50. The method of claim 47 wherein the external asset account is maintained by a financial institution.

51. The method of claim 47 wherein the term is for a set period of time.

52. The method of claim 47 wherein the term is for a covered person's lifetime.

53. The method of claim 47 wherein the guarantee is provided for one or more account owners of the external account.

54. The method of claim 53 wherein the term is for lifetime of longest surviving covered person.

55. The method of claim 47 wherein the term does not start until some defined point in the future.

56. The method of claim 47 wherein calculating a periodic payment for a term is based on a rollup value of the external asset account.

57. The method of claim 47 wherein the periodic payments may increase by an amount tied to an increase, if any, in the value of an external index.

58. The method of claim 47 wherein the periodic payments may increase by an amount tied to an increase, if any, in the value of the external asset account.

59. The method of claim 47 wherein calculating a periodic payment for a term is based on actuarial factors pertaining to a covered person.

60. The method of claim 47 wherein calculating a periodic payment for a term is recalculated if the external asset account is withdrawn in excess of the modal withdrawal limit.

61. The method of claim 47 wherein if the external asset account is withdrawn by an amount less than a modal withdrawal limit for a modal period, difference will be added to the modal withdrawal limit for a subsequent modal period.

62. The method of claim 47 wherein a lump sum payment is paid based on death of one or more covered persons.

63. The method of claim 47 wherein charges are assessed based on the value of the external asset account.

64. The method of claim 47 wherein charges are assessed based on the value of a benefit base.

65. The method of claim 47 wherein if the value of the external asset account multiplied by the modal withdrawal limit factor is greater than the current modal withdrawal limit, benefit base will be changed to equal current value of the external asset account.

66. The method of claim 50 wherein daily data feeds from the financial institution to insurance company and vice versa are required to administer the annuity product.

67. The method of claim 47 wherein an optimizer is utilized to determine an optimal portion of assets in the external asset account to be incorporated into the annuity product.

68. The method of claim 47 wherein the guarantee of periodic income is paid from the external asset account until value of the external asset account reaches a threshold value.

69. The method of claim 68 wherein the guarantee of periodic income is paid by the entity issuing the guarantee after the value of the external asset account reaches the threshold value.

70. The method of claim 47 wherein setting parameters further comprises maintaining a proper asset allocation within the external account.
